(19) United States
(12) Patent Application Publication
(10) Pub. No.: US 2022/0268523 A1
(43) Pub. Date: Aug. 25, 2022

(54) CAMERA-ENABLED MACHINE LEARNING FOR DEVICE CONTROL IN A KITCHEN ENVIRONMENT

(71) Applicant: Inirv Labs, Inc., Durham, NC (US)

(72) Inventors: Ranjith Babu, Durham, NC (US); Akshita Iyer, Durham, NC (US)

(21) Appl. No.: 17/180,598

(22) Filed: Feb. 19, 2021

(51) Int. Cl. F27D 21/00; G08B 17/10; G06K 9/62; F24C 7/08

(52) U.S. Cl. CPC F27D 21/00; G08B 17/10; G06K 9/6256; G06K 9/6277; G06K 9/6253; F24C 7/081; F27D 2021/0057; F27D 2021/026

(57) ABSTRACT

A cooking control system accesses a set of training data used to train a machine learned model configured to detect smoke in a kitchen environment based on image data of a stovetop. The cooking control system receives real-time image data of a stovetop from a camera in the kitchen environment and applies the machine learned model to the image data to determine a likelihood that the image data includes smoke. If the cooking control system determines that the received images contain smoke, the cooking control system may perform one or more actions, such as disabling operation of the stovetop and sending an alert indicative of smoke to a user of he cooking control system or a local emergency department.

### BACKGROUND

This invention relates generally to device control in a kitchen environment, and, more particularly, to using a machine learning model to determine the occurrence of triggering conditions that require actions to be performed within a kitchen environment.

When cooking in a kitchen, specifically at a stovetop, a variety of scenarios may occur that affect the kitchen, the food being cooked, or the people in the kitchen or other nearby rooms. For example, if food is left unattended on a stovetop, the food may begin to burn if the heat on the stovetop is too high or the food is cooked for too long. This may be dangerous as the food could smoke or catch fire. In another example, if a pot of boiling water is left unattended, the water may boil over, creating a mess in the kitchen. Thus, a system that can control the stovetop or alert a user to a potential issue in the kitchen may help prevent messes and safety hazards.

Furthermore, other common issues within a kitchen environment include running out of ingredients to make particular recipes or not knowing dishes to cook using ingredients already available in the kitchen. Therefore, a system for understanding the inventory of a kitchen and recommending recipes can help improve a user's cooking experience.

### SUMMARY

The following disclosure describes a cooking control system that performs actions in a kitchen environment based on sensor data captured at a stovetop. In particular, the cooking control system accesses a set of training data and uses the set of training data to train a machine learned model configured to detect one or more triggering conditions that cause one or more actions to be performed. The machine learned model is configured to detect a variety of issues within the kitchen environment based on image data of a stovetop. Examples of issues include smoke, water boil over, unattended food being cooked, and the like. The cooking control system receives real-time image data (and, in some embodiments, other sensor data) from a sensor system in the kitchen environment and applies the machine learned model to the image data. The machine learned model may determine a likelihood that the image data is indicative of one or more triggering conditions occurring, such as smoke or fire being in the kitchen environment, water boiling over on the stovetop, food being done cooking, and the like. If the cooking control system detects one of these triggering conditions, the cooking control system may perform an action related to the triggering condition. For example, if the cooking control system determines the stovetop has smoke or fire on it, the cooking control system may disable operation of the stovetop (e.g., by actuating a stovetop control) and may send an alert to a user of the stovetop or a local emergency department about the smoke or fire.

Furthermore, the cooking control system may suggest and adapt recipes based on sensor data captured in the kitchen environment. For instance, the cooking control system may access a set of training data and may train a machine learned model to determine contents (e.g., ingredients) of a pan siting on a stovetop. The cooking control system may receive image data captured in real-time from the stovetop and apply the machine learned model to the image data. The cooking control system may determine contents of the stovetop pan based on an output from the machine learned model and may determine a recipe being used based on the contents. As more ingredients are added to the stovetop, the cooking control system may adapt the recipe to accommodate the additional ingredients.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a system environment for a cooking control system, according to one embodiment.

FIG. 2 is a high-level block diagram of a cooking control system, according to one embodiment.

FIG. 3A is a flowchart illustrating a first portion of a process for performing actions in a kitchen environment, according to one embodiment.

FIG. 3B is a flowchart illustrating a second portion of a process for performing actions in a kitchen environment, according to one embodiment.

FIG. 4 is a flowchart illustrating a process for adapting a recipe, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

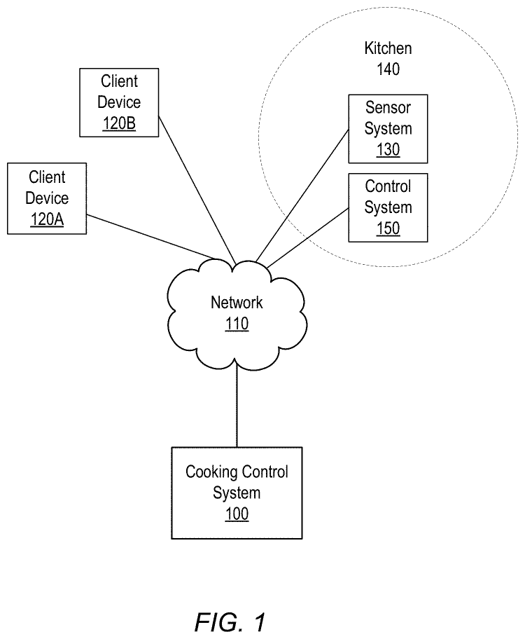

FIG. 1 illustrates a system environment for a cooking control system 100, according to one embodiment. The cooking control system 100 is connected to a number of client devices 120 used by users of a kitchen environment via a network 110. These various components are now described in additional detail.

The client devices 120 are computing devices such as smart phones, laptop computers, desktop computers, or any other device that can communicate with the cooking control system 100 via the network 110. The client devices 120 may provide a number of applications, which may require user authentication before a user can use the applications, and the client devices 120 may interact with the cooking control system 100 via an application. Though two client devices 120 are shown in FIG. 1, any number of client devices 120 may be connected to the cooking control system 100 in other embodiments. The client devices 120 may be located within a region designated as a kitchen environment for cooking or baking, such as in a home, restaurant, café, food truck, outdoor grill, and the like. The kitchen environment (henceforth referred to as a “kitchen” 140) may include one or more appliances or areas that are monitored by the cooking control system 100, including a stovetop, oven, refrigerator, sink, countertop, microwave, toaster, and the like. For the sake of simplicity, description herein will be limited to kitchens 140, though in practice, the methods described herein apply equally to any other region or venue where cooking or baking may occur.

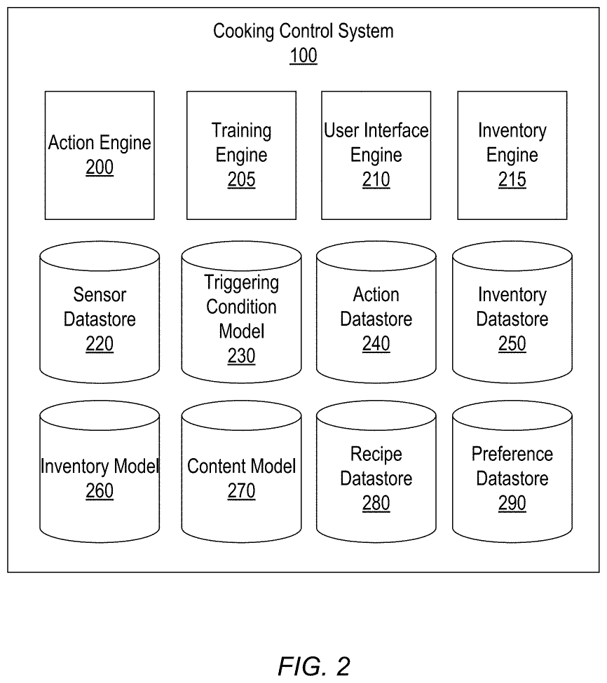

The network 110 connects the client devices 120 to the cooking control system 100, which is further described in relation to FIG. 2. The network 110 may be any suitable communications network for data transmission. In an embodiment such as that illustrated in FIG. 1, the network 110 uses standard communications technologies and/or protocols and can include the Internet. In another embodiment, the network 110 use custom and/or dedicated data communications technologies.

The network 110 connects a sensor system 130 in a kitchen 140 to the cooking control system 100 and one or more client devices 120. The sensor system 130 includes a plurality of sensors able to capture sensor data from within the kitchen 140. The plurality of sensors may include one or more cameras (e.g., a video camera, an infra-red camera, a thermographic camera, heat signature camera, etc.), a microphone, a smoke detector, LiDAR sensor, a temperature sensor, a heat sensor, pressure sensor, inertial measurement units, and the like. The sensors may gather sensor data used by the cooking control system 100 to detect triggering conditions that may require action, as is further described in relation to FIG. 2.

The network also connects a control system 150 of one or more controllers in the kitchen 140 to the cooking control system 100. The control system 150 may include a plurality of controllers coupled to the control system 150, and the controllers may be mechanical, electrical, hardware, software, wireless, and/or wired to the control system 150. The cooking control system 100 may communicate with the mechanical controllers to control appliances in the kitchen 140. For example, such mechanical controllers may include knob controllers mechanically coupled to knobs at a stovetop within the kitchen 140. The stovetop may be an induction stovetop, electrical stovetop, or gas stovetop. The cooking control system 100 may control the knobs to increase or decrease heat at a one or more portions of the stovetop, or to disable operation of the stovetop entirely. A device for controlling operational control of one or more burners in a stovetop is described in related U.S. Pat. No. 10,228,147, filed on Jun. 30, 2017, which is incorporated by reference in its entirety. Other mechanical controllers may be coupled to various appliances throughout the kitchen to control oven, refrigerator, microwave, dishwasher, and thermostat settings, and to turn on/off water at the sink, lights in the kitchen 140, and an oven fan.

FIG. 2 is a high-level block diagram of a cooking control system 100, according to one embodiment. The cooking control system operates in real-time to monitor a kitchen 140 using sensor data captured by the sensor system 130. Through monitoring the kitchen 140, the cooking control system 100 may determine whether a triggering condition that requires action has occurred in the kitchen 140, what products or ingredients are available in the kitchen 140, and a recipe to use in the kitchen. The cooking control system 100 includes an action engine 200, a training engine 205, a user interface engine 210, an inventory engine 215, a sensor datastore 220, a triggering condition model 230, an action datastore 240, an inventory datastore 250, an inventory model 260, a content model 270, a recipe datastore 280, and a preference datastore 290. In some embodiments, the cooking control system 100 may include more engines or models than shown in FIG. 2 or one or more of the engines and models shown in FIG. 2 may be combined within the cooking control system 100.

The action engine 200 facilitates the performance of one or more actions or operations by the cooking control system 100 based on triggering conditions that have occurred or are occurring in the kitchen 140. Triggering conditions are events or states that occur within the kitchen 140 that could result in an unsafe or nonideal scenario and need attention to remedy. For example, one triggering condition may be food catching on fire while being cooked on a stovetop within the kitchen. Another example triggering condition may be water boiling over in a pot on the stovetop. Other triggering conditions include that food is done cooking, food is ready to be flipped while cooking, smoke is in the kitchen 140, food has been left unattended while cooking, or knobs or buttons within the kitchen 140 are being turned or pressed erratically (e.g., by a child). To remedy each triggering condition, one or more actions can be performed. Actions are operations performed by the cooking control system 100 or control system 150 to change a functionality or state of a kitchen device or appliance or alert one or more individuals to a state of the kitchen 140. Examples of actions include disabling a flow of gas to the stovetop to put out a fire, turning down heat on the stove, sending a notification to a user indicating that a pot needs to be removed from the stovetop, and the like.

To detect triggering conditions, the action engine 200 receives sensor data directly from the sensor system 130 in-real time, or accesses recently stored sensor data from the sensor datastore 220. The sensor data may include image data, heat data (or other temperature data), smoke data, LiDAR/radar data, audio data, and infra-red data (or other thermographic data). Though the sensor data may include a plurality of different types of data, for simplicity, any data captured by the sensor system and/or used by the cooking control system 100 is collectively referred to herein as sensor data.

The action engine 200 applies the triggering condition model 230 to the sensor data, which is a machine learned model, such as a classifier, decision tree, regression model, or neural network, configured to detect a plurality of triggering conditions in the kitchen 140. In some embodiments, the action engine 200 applies the triggering condition model 230 to only a subset of the sensor data, such as only image data captured by cameras of the sensor system 130 or only smoke data captured by a smoke detector of the sensor system 130 (despite other sensor data being available). Though described as one model in the following description, in some embodiments, triggering condition model 230 may be comprised of a plurality of machine learned models that each determines the likelihood of a triggering condition occurring in the kitchen 140. However, for simplicity, the following description pertains to the use of one machine learned model (e.g., the triggering condition model 230). Furthermore, in some embodiments, the triggering condition model 230 may be another type of model or classifier that detects triggering conditions and does not use machine learning.

The triggering condition model 230 may be trained by the training engine 205 using one or more sets of training data. The training data may be labeled sensor data stored in the sensor datastore 220 and can include data previously captured by the cooking control system 100 or another cooking control system. In some embodiments, the triggering condition model 230, when applied to sensor data representative of a stovetop, can output one or more likelihoods indicating whether one or more triggering conditions is occurring or has occurred in the kitchen 140.

The action engine 200 receives the one or more likelihoods from the triggering condition model 230. The action engine 200 compares each likelihood to a threshold to determine whether one or more triggering conditions is occurring in the kitchen 140. If a likelihood exceeds a corresponding threshold, then the action engine 200 may determine that a triggering condition is occurring. In other embodiments, the output of a triggering condition model is a binary representation of whether or not a triggering condition is occurring. The triggering condition model 230 model, triggering conditions, and likelihoods are further described in examples below in the description of FIG. 2.

The action engine 200 performs one or more actions based on the determined triggering conditions. In particular, the action engine 200 identifies one or more actions to perform for each determined triggering condition from the action datastore 240. Actions may include sending an indication of the triggering condition to the user interface engine 210 to disable operation of or turn down a burner on a stovetop, send a notification for display on a client device 120, sending an alert to local emergency services, controlling one or more appliances within the kitchen 140 via the control system 150, and the like. Examples of actions are further described below in relation to the triggering condition model 230. In some embodiments, the action engine 200 may also perform actions upon receiving indications from the user interface engine 210 of an action provided by a user via a user interface, as described below.

The inventory engine 215 determines an inventory of the kitchen based on sensor data captured by the sensor system 130. In particular, the inventory engine 215 may assess image data captured by the sensor system 130 to determine what food items or ingredients, utensils, appliances, and other supplies (e.g., aluminum foil, plastic wrap, brown paper bags, etc.) are currently in the kitchen 140. In some embodiments, the inventory engine 215 may use a digital processing algorithm to identify food items, utensils, appliances, and supplies in the kitchen using images captured within the image data, including brand, quantity, and type (e.g., bok choy versus baby bok choy or plastic bags versus paper bags). In other embodiments, the inventory engine 215 may use an inventory model 260 to the inventory of the kitchen based on image data. The inventory model 260 may be a machine learned model, such as a classifier, decision tree, regression model, or neural network. The machine learned model may be trained by the training engine 205 on images of supplies in a kitchen labeled with name, brand, quantity, and type of the supply. The inventory engine 215 may store the inventory in the inventory datastore 250 and update the inventory datastore based on image data captured as supplies are used or replenished in the kitchen 140. The inventory engine 215 may also store and update a grocery list of supplies that have been used up in the kitchen within the inventory datastore 250.

The inventory engine 215 may determine recipes to suggest for a user to follow based on the contents in a container in the kitchen 140. For example, if a user is cooking in the kitchen 140, the inventory module 215 may determine, using the content model 270, what ingredients the user is cooking with and match the ingredients with a recipe to determine what the user is cooking. The inventory module 215 may make suggestions to the user (sent by the user interface module 215 via a user interface on a client device 120) and perform actions to aid the user as they cook based on the determined recipe. For example, the inventory module 215 may suggest instructions to the user for a next step in the determined recipe, flag that the user missed a step in the recipe, turn on appliances to preheat or otherwise prepare for use as the user makes the recipe, and the like.

In particular, the inventory engine 215 can receive sensor data from the sensor system 130 and input the sensor data to the content model 270. The content model 270 may determine the contents (e.g., ingredients/food) of a container (e.g., a pot, pan, bowl, etc.) in the kitchen 140. The content model 270 may be a machine learned model trained by the training engine 205 on image data of food in containers in a kitchen labeled with each food in the container. The content model 270 may output a likelihood of each of one or more foods being in the container, and the inventory engine 215 may select foods with a likelihood above a threshold as being part of the contents of the container. In some embodiments, the content model 270 may also output a quantity of each food along with the likelihoods.

Based on the contents, the inventory engine 215 determines a recipe to suggest from the recipe datastore 280, which is an index of recipes. Each recipe may include a set of ingredients and supplies needed to complete the recipe, a set of instructions for the recipe, and characteristics associated with the recipe. The inventory engine 215 may select one or more recipes from the recipe datastore 280 recipes based on the determined contents of the container, recipes previously followed by the user (determined based on selection via the user interface described below or image data of the user cooking in the kitchen 140), and characteristics of the user, which are described below in relation to the user interface engine 210. The inventory engine 215 may send the selected recipes to the user interface engine 210 for display via a user interface. Alternatively, if the user has begun cooking, the inventory engine 215 may select which recipe the user is most likely to be following based on the contents and supplies available in the kitchen 140 and send the recipe to the user interface engine 210 for display via he user interface.

The inventory engine 215 may receive indications from the user interface engine 210 that a user has selected a recipe to follow. The inventory engine 215 may monitor the user's progress following the recipe using image processing techniques or machine learned models on sensor data captured within the kitchen 140. For instance, the inventory engine 215 may determine that pasta that the user is cooking is al dente based on image data and temperature data of the pasta and send an indication to the user interface engine 210 that the user should remove the pasta from heat. In another example, the inventory engine 215 may detect that the user has added eggs to a pan and send an indication to the user interface engine 215 to display a next step of the recipe via a user interface. Additionally, the inventory engine 215 may adapt a recipe based on a quantity of food added by the user, as determined from the sensor data. For example, the inventory engine 215 may scale quantities of ingredients recommended for the recipe or remove ingredients from the recipe based on the quantity and type of food added. The inventory engine 215 may update the recipe in the recipe datastore 280 and send indications of the adaptations to the recipe to the user interface engine 210.

The user interface engine 210 generates and transmits a user interface to one or more client devices 120 of users of the kitchen 140. The user interface may display notifications or alerts sent by the action engine 200 in response to determining one or more triggering conditions are occurring in the kitchen 140. For instance, the user interface may display an alert indicating that a fire is in the kitchen 140 and may include an interactive element that allows the user to indicate they would like to alert local emergency services. In some embodiments, the user interface may display interactive elements with notifications and alerts such that a user may promptly indicate an action for the action engine 200 to perform in the kitchen 140. Upon receiving the interaction, the user interface engine 210 (or, in some embodiments, the action engine 200) may use the control system 150 to perform an action associated with the interactive element, such as turning off the oven, locking knobs at the stovetop, and the like. The user interface may display additional interactive elements that the user may interact with to control appliances within the kitchen via the control system 150, regardless of if an alert or notification was displayed. For instance, a user may interact with an interactive element indicating that they would like to lock knobs at a stovetop from turning, and the user interface engine 210 may interact with the control system 150 to lock the knobs at the stovetop and prevent the knobs form unlock without two-factor authentication from the user interface. The user may also interact with the interactive elements to view real-time video of the kitchen 140, control the temperature of the oven, turn on the dishwasher, activate the toaster, turn off the lights, and the like.

Furthermore, the user interface may include statistics about triggering conditions in the kitchen 140 determined from the sensor data. Examples of statistics include density of smoke, density of steam, temperature, and whether any appliances are currently in use (e.g., the oven is on at 350 degrees Fahrenheit or the microwave is activated for another 30 seconds). The user interface may also display the inventory of food, utensils, and supplies in the kitchen 140 stored in the inventory datastore 250, a grocery list of supplies that are out of stock in the kitchen, and suggested recipes determined by the inventory engine 215. If a user indicates, via an interaction with a suggested recipe on the user interface, that they would like to use the recipe, the user interface engine 210 may send instructions for the recipe for display via the user interface. The user interface engine 210 may communicate with the inventory engine 215 as the user is following the recipe to determine which instructions to display based on the user's movements within the kitchen 140.

The user interface may display interactive elements that allow a user to indicate preferences for the cooking control system to follow. For example, the user may configure thresholds used by the cooking control system 100 to determine whether to perform actions (such as temperature thresholds, smoke thresholds, and the like), what actions are performed when a threshold is met, how the user like their food cooked (e.g., well-done or rare), and characteristics about their cooking habits (e.g., they only make vegetarian food). The user interface engine 210 may receive these preferences from the user interface and store the preferences in the preference datastore 290. The user interface engine 210 may update the preferences stored in the preference datastore 290 as the user adds or changes their preferences over time.

### Examples of Triggering Condition Detection

As discussed herein, the action engine 200 may use the triggering condition model 230 to determine triggering conditions that are occurring or have occurred in the kitchen 140. Examples of such triggering condition detection are described in detail below.

Smoke and Steam Detection:

The action engine 200 may employ the triggering condition model 230 to detect smoke and/or steam in the kitchen 140. The presence of smoke may be indicative of a fire and may cause health risks for individuals in or near the kitchen. Further, the presence of steam may indicate that water or other liquids in the kitchen have boiled over or that food is cooking. Due to the potential health and safety risks posed by smoke and the visual similarity between smoke and steam, the triggering condition model 230 is configured to differentiate between smoke and steam.

In particular, the training engine 205 may train the triggering condition model 230 on training data labeled as including smoke, steam, both, or neither. The training data may include images of smoke, steam, both, or neither, and temperature data, smoke data, and LiDAR data captured when smoke, steam or neither was present in a kitchen 140. The training data may be further labeled with a density of smoke or steam and as posing a risk or not to the kitchen 140 and surrounding environment in cases of smoke.

After receiving sensor data from the action engine 200, the triggering condition model 230 may output a set of likelihoods of the sensor data including smoke, steam, both, or neither. The action engine may compare each of the set of likelihoods to a smoke threshold, steam threshold, smoke and steam threshold, and an “all clear” threshold (e.g., both steam and smoke are below respective thresholds) (collectively “thresholds”), to determine whether the kitchen contains smoke, steam, both, or neither, respectively. In some embodiments, the thresholds may be default thresholds or may be standard for the cooking control system. In other embodiments, a user may set, via a client device 120, the thresholds based on the user's levels of comfort with smoke and steam being in the kitchen 140. If the likelihood of the kitchen 140 containing smoke exceeds the smoke threshold, the action engine 200 may retrieve an action from the action datastore 240 related to smoke being in the kitchen 140 and complete the action. Such actions include sending a notification to a client device 120 of a user that smoke has been detected in the kitchen 140, disabling operation of the stovetop or other appliances in the kitchen 140 by instructing the control system 150 to actuate a controller of the stovetop or other appliances, or sending a notification to local emergency services indicating that smoke is in the kitchen 140. The notification may be accompanied with a location of the kitchen 140 and real-time video of the smoke, if no one is within a threshold distance of the kitchen 140. The action engine 200 may retrieve and complete similar actions if the likelihood of steam exceeds the steam threshold or the likelihood of smoke and steam exceeds the smoke and steam threshold.

In alternate embodiments, the triggering condition model 230 may output a density (or amount) of smoke and/or steam in the kitchen 140 based on the sensor data. In this case, the action engine 200 may compare the density to a threshold density. The threshold density may represent a standard dangerous level or smoke and/or steam or may be configured by a user of the kitchen 140 to be at a lower level based on their level of comfort around smoke and/or steam. If the density exceeds the threshold density, the action engine 200 may send a notification to a user that the density of smoke/steam in the kitchen 140 exceeds the threshold density. Alternatively, the action engine 200 determine whether a user is within a threshold distance of the kitchen 140 (i.e., in the next room or not). If a user is nearby, the action engine 200 determines that a user is nearby, the action engine 200 may sound an alarm in the kitchen 140, and if not, the action engine 200 may send an alert to a local emergency service indicating a location of the kitchen 140 and the presence of smoke/steam in the kitchen 140. In another embodiment, the triggering condition model 230 may output a likelihood of risk to the kitchen 140 and its surrounding environment. If the risk exceeds a risk threshold, the action engine may send a notification to the user or alert local emergency services. Such actions described in relation to each embodiment may be stored in the action datastore 240 for the action engine 200 to retrieve and complete when the threshold density and/or risk threshold is exceeded.

Fire Detection: During cooking, fire may accidentally or purposefully occur. For instance, a dish that is being flambeed should have fire on it and a dish being cooked on a gas burner should have fire under it. However, a pan-fried chicken generally should not have fire on it when cooking. Fire may pose serious health risks if occurring in a kitchen 140 under certain circumstances (i.e., when a dish is not being flambeed or cooked over a gas burner), so the action engine 200 may employ the triggering condition model 230 to detect fire in the kitchen 140.

In particular, the triggering condition model 230 may be trained to detect fire in the kitchen 140. The training engine 205 may train the triggering condition model 230 on images of fires in a kitchen 140 labeled as posing a risk to the kitchen 140 or not. For example, images with fire above a threshold (e.g., taking up a threshold portion of an image) may be labeled as posing a risk to the kitchen 140 and surrounding environment while images with fire under a pan (e.g., for a gas stove) or for a flambéing food may be labeled as not posing a risk. Alternatively, the images may be labeled with an amount of fire shown in the images.

After receiving sensor data from the action engine 200, the triggering condition model 230 may output a likelihood of risk from fire to the action engine 200. If the likelihood is above a fire threshold, the action engine 200 may retrieve one or more actions to perform from the action datastore 240. In other embodiments, the triggering condition model 230 may output an amount of fire shown in the sensor data. If the amount of is above a fire threshold, the action engine 200 may retrieve one or more actions to perform from the action datastore 240. Such actions may include alerting a user of the fire, alerting local emergency services of a location of the fire, sending a real-time video of the fire to the user and/or local emergency services, turning on sprinkler system within the kitchen 140, determining a type of fire (e.g., an electrical fire or a cooking oil fire) based on the sensor data, and sending the type of fire to the user and/or local emergency services.

Boiling Detection:

When users are boiling water (or other liquids) in a kitchen, they may leave the pot of water to go to another room given that water often takes a few minutes to boil. However, the user may not have a way of knowing if the water has begun boiling, which could lead to the water boiling over and causing amess in the kitchen 140. To prevent this, the triggering condition model 230 may be configured to detect boiling water (or other liquids) in image data of the stovetop in the kitchen 140.

In particular, the training engine 205 may train the triggering condition model 230 on images of water and other liquids on a stovetop labeled as still, boiling, or boiling over. Furthermore, the training engine 205 may additionally train the triggering condition model 230 on audio data labeled as the sound of boiling or boiling over water or other liquids. After receiving sensor data from the action engine 200, the triggering condition model 230 may output a first likelihood that water on the stovetop water is boiling and a second likelihood that the water is boiling over. If the first likelihood is above a first threshold but the second likelihood is not above a second threshold, the action engine 200 may send an alert to a client device 120 of a user indicating that the water is boiling, turn down the temperature of a burner at the stovetop to prevent boil over, and/or send a notification to the user that water is ready to have food (e.g., pasta, rice, etc.) added. If the first likelihood is above the first threshold and the second likelihood is above the second threshold, the action engine 200 may send an alert to a client device 120 of a user indicating that the water is boiling over and/or turn down the temperature of a burner at the stovetop via the control system 150. These actions are stored in the action datastore 240 for the action engine 200 to retrieve upon detecting that the first and/or second threshold have been exceeded.

Cooking Detection:

Similar to when boiling water, users may sometimes leave food unattended for a few minutes when cooking since food often takes a few minutes to fully cook. However, in doing so, a user may forget about the food or return to it later than anticipated, which may result in the food becoming burnt. In addition, food may be cooked in a variety of method (e.g., in a pan on the stovetop, in an oven, in a microwave, in a sous vide container, etc.), and users may have difficulty determining when food is fully cooked if they are unfamiliar with a method, resulting in burned or undercooked food. To help prevent this, the triggering condition model 230 may also be configured to detect whether food is done or needs to be flipped.

The training engine 205 may train the triggering condition model 230 on infra-red image data of cooking food labeled as ready (e.g., to eat or to flip over) or not based on the type of food in the image data, a standard temperature the surface of the food needs to reach before being ready to eat (e.g., meat needs to reach a higher surface temperature than vegetables to be safely edible), and/or a color of the external surface of the food (e.g., beef turns brown when cooked and is read when uncooked). After the action engine 200 inputs sensor data to the triggering condition model 230, the triggering condition model 230 may output a likelihood that the food is ready or not. Alternatively, the triggering condition model 230 may output a likelihood that the temperature of the food has reached a threshold (i.e., the standard temperature of the surface to be done cooking). If the likelihood is above a threshold, the action engine 200 may retrieve one or more actions from the action datastore 240 to perform, such as sending an alert to a user that the food is ready to eat or be flipped or turning down the temperature at the appliance via the control system 150.

Unattended Cooking Detection:

To also help prevent food from becoming burned, which by lead to a fire or smoke in the kitchen 140, the action engine 200 may employ the triggering condition model 230 to detect whether cooking food has been left unattended in the kitchen 140. The triggering condition model 230 may be trained by the training engine 205 to determine whether food has been left unattended using labeled sensor data of cooking food being attended to or not. For example, sensor data including images of a user in the kitchen 140 and audio data of the user talking while food sizzles in the background may be labeled as being attended to. The action engine 200 may input sensor data to the triggering condition model 230, and the triggering condition model 230 may output a likelihood that food cooking in the kitchen is unattended or not. If the likelihood is below an attention threshold, the action engine 200 may send a notification to a user indicating the food is unattended or turn off an appliance being used to cook the food.

In some embodiments, the action engine 200 may determine what type of appliance is being used to cook the food and compare the likelihood to a threshold configured by the user for that appliance. For instance, the user may indicate, via preferences entered via a user interface, that the oven may be left unattended indefinitely while cooking food whereas the stovetop may only be left unattended for one minute. The action engine 200 may use these preferences to determine whether to perform one or more actions based on the likelihood output by the triggering condition model 230.

Erratic Knob/Button Movement Detection:

Some kitchens 140, such as those in households with small children, may have appliances that are subject to erratic movement. For example, a child may go into the kitchen 140 and turn knobs or press buttons on the oven erratically. If food is currently cooking in the oven, this may cause the cook to over- or undercook. To prevent this, the action engine 200 may employ the triggering condition model 230 to detect erratic knob movement or button pressing. In particular, the triggering condition model 230 may be trained by the training engine 205 on sensor data of labeled based on erratic movements. For example, this may include image data of a child pressing buttons on an oven while the oven is on, data captured by the control system of the knobs being moved without input from the control system 150, or data captured from inertial measurement units on knobs at a stovetop showing a full turn of a knob multiple times. The triggering condition model 230 output a likelihood of erratic movement for each of one or more buttons or knobs in the kitchen 140 upon receiving sensor data as input from the action engine. If a likelihood is over a an erratic movement threshold, the action engine 200 may lock the button or knob from being activated or turn, return a setting associated with the button or knob to its previous setting, turn off an appliance associated with the button or knob, or send a notification to a user that the button or knob was pressed or moved.

### Cooking Control System Processes

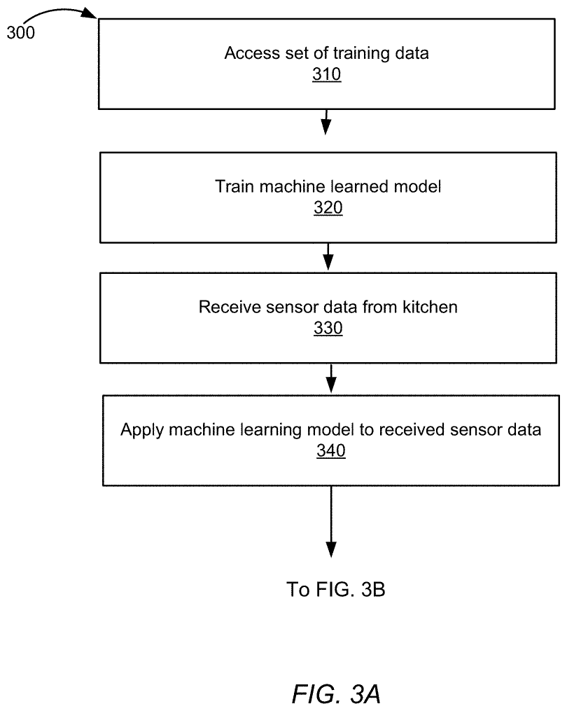

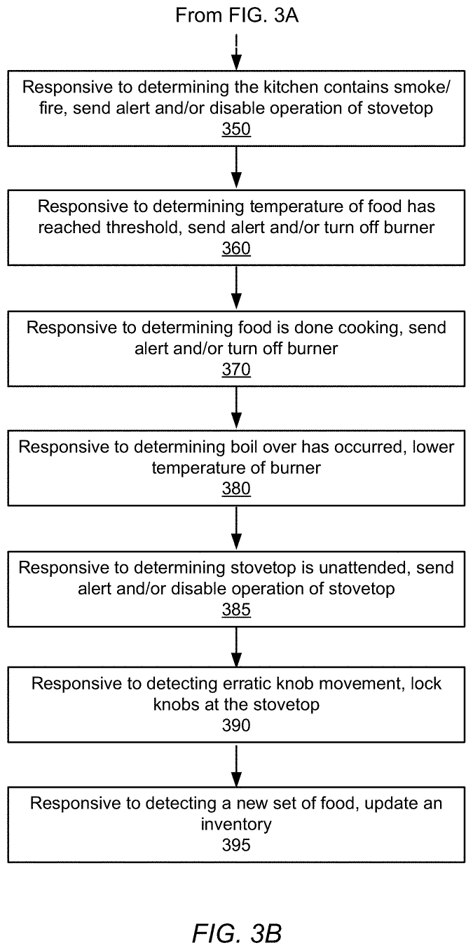

FIGS. 3A and 3B include a flowchart illustrating a process 300 for performing actions in a kitchen 140, according to one embodiment. Though reference is made to engines of the cooking control system 100 for this process 300, the process can be used by other online systems or mobile applications for performing actions based on triggering conditions detected in a kitchen 140.

The training engine 205 of the cooking control system accesses 310 a set of training data from the sensor datastore 220 and trains 320 the triggering condition model 230 (or another machine learned model) on the training data to detect instances occurring in a kitchen 140. The action engine 200 receives 330 real-time sensor data from the kitchen 140 and applies the triggering condition model 230 to the received sensor data 340. In some embodiments, the action engine 200 may only apply the triggering condition model 230 to a subset of the sensor data, such as image data of a stovetop. The action engine 200 may receive one or more likelihoods indicating triggering conditions that are occurring in the kitchen 140. If a likelihood exceeds a threshold, the action engine 200 may determine that the corresponding triggering condition is occurring and perform one or more actions.

For example, responsive to determining 350 that the kitchen 140 contains smoke or fire, the action engine 200 may send an alert to local emergency services and/or disable operation of the stovetop via the control system 150. In another embodiment, the user interface engine 210 may send an alert for display via a user interface of a client device 120. The user interface engine 210 may send an alert for display via a user interface indicating that the food is done cooking responsive to determining 360 that the temperature of food that is cooking has reached a threshold or responsive to determining 370 that the food is done cooking. Alternatively, the user interface module may turn off a burner at the stovetop or other appliance responsive to determining 360 the temperature of the food has reached the threshold or responsive to determining 370 that the food is done cooking. Furthermore, responsive to determining 380 that boil over has occurred, the action engine 200 may lower, via the control system 150, a temperature of a burner corresponding to the pot that has boiled over. Responsive to determining 385 that the stovetop (or another appliance in the kitchen 140) is unattended while food is cooking, the user interface engine 210 may send an alert for display via the user interface indicating that the food is unattended and/or disable operation of the stovetop. Responsive to detecting 390 erratic knob or button movement in the kitchen 140, the action engine may lock the knobs or buttons from altering settings of a corresponding appliance in the kitchen 140.

In some embodiments, the machine learned model trained by the training engine 205 may be the inventory model 260. Thus, in the process shown in FIGS. 3A and 3B, the inventory engine 215 may receive 330 sensor data from the sensor system 130 and apply 340 the inventory model 260 to the sensor data to determine a new or updated inventory of the kitchen 140. Responsive to detecting 395 a new set of food items being brought into the kitchen 140, the inventory engine 215 may update the inventory of the kitchen 140 in the inventory datastore 250.

It is appreciated that although FIG. 3 illustrates a number of interactions according to one embodiment, the precise interactions and/or order of interactions may vary in different embodiments. For example, in some embodiments, the user interface engine 210 turn off an appliance cooking food responsive to determining that the food is done cooking.

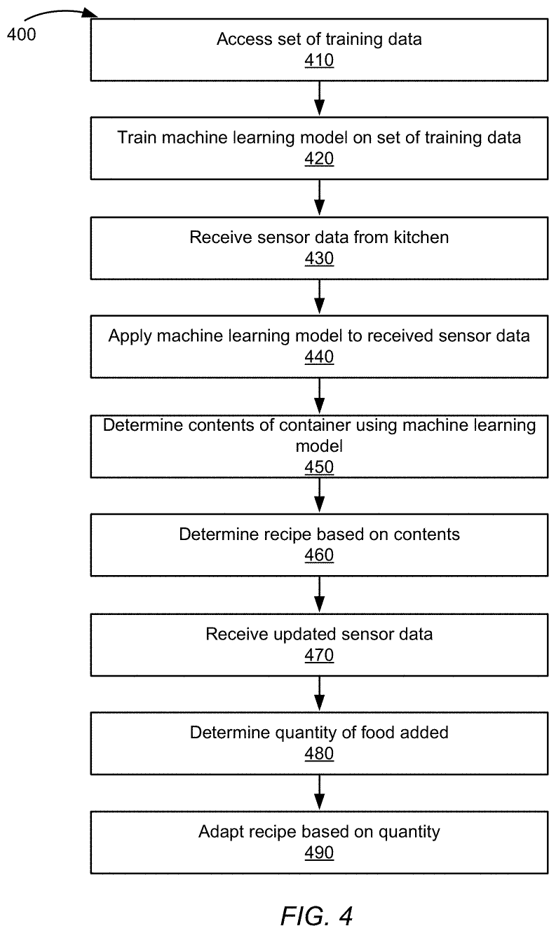

FIG. 4 is a flowchart illustrating a process 400 for adapting a recipe, according to one embodiment. The training engine 410 of the cooking control system accesses 410 a set of training data from the sensor datastore 220 and trains 420 the content model 270 (or another machine learned model) on the training data to detect triggering conditions occurring in a kitchen 140. The inventory engine 260 receives 430 sensor data from the kitchen 140, such as image data from the stovetop, and applies 440 the content model 270 to the received sensor data. The inventory engine 260 determines 450 contents of a container in the kitchen 140 based on output from the content model 270.

Based on the contents, the inventory engine 260 determines a recipe 460 that a user may be following. The inventory engine 260 receives updated sensors data indicating that the user has performed an action in the kitchen 140 that the contents of the container have changed, which the inventory engine 260 may determine applying the content model 270 again. The inventory engine 260 may determine 480 a quantity of food added to the container using the content model 270 and adapt 490 the recipe based on the quantity.

It is appreciated that although FIG. 4 illustrates a number of interactions according to one embodiment, the precise interactions and/or order of interactions may vary in different embodiments. For example, in some embodiments, the inventory engine 260 may adapt the recipe multiple times as food is added or removed from the container.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for controlling a stove, the method comprising:
accessing a set of training data, the training data comprising image data of stovetops labeled based on presence of smoke;
training, using the set of training data, a machine learning model configured to detect smoke in images of a stovetop;
receiving, in real-time from a camera, images of a stovetop;
applying the machine learning model to the received images to determine a likelihood that the received images include smoke; and
responsive to determining that the received images include smoke, disabling operation of the stovetop and sending an alert indicative of smoke at the stovetop.

2. The method of claim 1, wherein the training data further comprises one or more of LiDAR data and heat signature data.

3. The method of claim 1, wherein the machine learning model is further configured to distinguish between steam and smoke in image data of a stovetop.

4. The method of claim 1, wherein the received images are determined to include smoke in response to the machine learning model determining that there is an above-threshold likelihood that the received images include smoke.

5. The method of claim 1, wherein determining that the received images include smoke comprises determining that the received images include an above-threshold amount of smoke, and wherein the threshold amount of smoke may be adjusted via a user interface presented to a client device of a user of the stovetop.

6. The method of claim 1, wherein the alert is sent via a user interface presented to a client device of a user of the stovetop.

7. The method of claim 1, wherein sending the alert comprises sending the alert to a local emergency department.

8. The method of claim 1, wherein the alert comprises one or more of the received images of the stovetop.

9. The method of claim 1, wherein disabling operation of the stovetop comprises actuating a mechanical stovetop controller configured to turn off the stovetop.

10. The method of claim 1, wherein the machine learning model is further configured to detect fire in images of a stovetop that include smoke.

11. A non-transitory computer-readable storage medium comprising instructions executable by a processor, the instructions comprising:
instructions for accessing a set of training data, the training data comprising image data of stovetops labeled based on presence of smoke;
instructions for training, using the set of training data, a machine learning model configured to detect smoke in images of a stovetop;
instructions for receiving, in real-time from a camera, images of a stovetop;
instructions for applying the machine learning model to the received images to determine a likelihood that the received images include smoke; and
responsive to determining that the received images include smoke, instructions for disabling operation of the stovetop and sending an alert indicative of smoke at the stovetop.

12. The non-transitory computer-readable storage medium of claim 10, wherein the training data further comprises one or more of LiDAR data and heat signature data.

13. The non-transitory computer-readable storage medium of claim 10, wherein the machine learning model is further configured to distinguish between steam and smoke in image data of a stovetop.

14. The non-transitory computer-readable storage medium of claim 10, wherein the received images are determined to include smoke in response to the machine learning model determining that there is an above-threshold likelihood that the received images include smoke.

15. The non-transitory computer-readable storage medium of claim 10, wherein the instructions for determining that the received images include smoke comprise instructions for determining that the received images include an above-threshold amount of smoke, and wherein the threshold amount of smoke may be adjusted via a user interface presented to a client device of a user of the stovetop.

16. The non-transitory computer-readable storage medium of claim 10, wherein the alert is sent via a user interface presented to a client device of a user of the stovetop.

17. The non-transitory computer-readable storage medium of claim 10, wherein the instructions for sending the alert comprise instructions for sending the alert to a local emergency department.

18. The non-transitory computer-readable storage medium of claim 10, wherein the alert comprises one or more of the received images of the stovetop.

19. The non-transitory computer-readable storage medium of claim 10, wherein the instructions for disabling operation of the stovetop comprise instructions for actuating a mechanical stovetop controller configured to turn off the stovetop.

20. A computer system comprising:
a computer processor; and
a non-transitory computer-readable storage medium storage instructions that when executed by the computer processor perform actions comprising:
accessing a set of training data, the training data comprising image data of stovetops labeled based on presence of smoke;
training, using the set of training data, a machine learning model configured to detect smoke in images of a stovetop;
receiving, in real-time from a camera, images of a stovetop;
applying the machine learning model to the received images to determine a likelihood that the received images include smoke; and
responsive to determining that the received images include smoke, disabling operation of the stovetop and sending an alert indicative of smoke at the stovetop.
